(19) United States
(12) Patent Application Publication
(10) Pub. No.: US 2026/0103016 A1
(43) Pub. Date: Apr. 16, 2026

(54) MULTIPURPOSE JOURNAL

(71) Applicant: Azenath Adede, Brooklyn, NY (US)

(72) Inventor: Azenath Adede, Brooklyn, NY (US)

(21) Appl. No.: 18/912,042

(22) Filed: Oct. 10, 2024

(51) Int. Cl. B42D 3/18; B42D 1/06

(52) U.S. Cl. CPC B42D 3/18; B42D 1/06

(57) ABSTRACT

A multipurpose journal includes a plurality of pages bound by a soft cover. The soft cover can include a plurality of attachments on a spine where a shoulder strap can be attached thereto. The soft cover includes at least one pocket disposed thereon and secured by at least one fastener. The at least one pocket includes a plurality of storage components configured to store personal items. A strap can be affixed to a portion of the soft cover and can be configured to secure the multipurpose journal in a closed configuration. In a journaling configuration a user may open the soft cover to expose the plurality of pages and may write thereon. In a stored configuration the user may place a plurality of items in the at least one pocket and place the shoulder strap around an appendage utilizing the journal as a carrying case.

### BACKGROUND OF THE INVENTION

### Field of Endeavor

The present invention relates to journals, and more particularly, to a multipurpose journal having storage integral thereto.

### Background of Related Art

Journaling, or recording your thoughts, feelings, experiences, reflections, etc., has been associated with several benefits. It has been shown that journaling can improve writing and communication skills, goal achievement, mental health, inspiration, memory, and overall self-care. However, those wanting to journal are faced with hurdles associated why transportation, storage, and management of a journal. Traditionally, a journal is a separate item that must be transported, and managed in addition to other items a user must carry in their daily lives, such as purses, wallets, identification, payment devices, etc. Traditional journals require a user to have a bag large enough to fit their journal, or to buy a journal holder, which is not integral to the journal, and costs additional money.

As can be seen, there is a need for a multipurpose journal configured to store necessary items thereby eliminating the burden of transporting and/or tracking multiple items, and/or costs associated with purchasing additional products.

### SUMMARY OF THE INVENTION

In one aspect of the present invention, a multipurpose journal is provided. The multipurpose journal can include a first cover continuously attached to a second cover having a spine disposed between the first cover and the second cover. A plurality of pages used for journaling, or other writing, can be bound to an internal surface of the spine. At least one pocket can be disposed within at least one of the first cover or the second cover, the at least one pocket being secured to the first cover or the second cover by at least one first fastener, such as a zipper, button, or magnet. The at least one pocket can include a first plurality of card pockets at least partially overlap and are in alignment, either horizontally or vertically, such that a user can store cards therein with minimal space. At least one id card pocket can be included in the pocket and can have at least one opening and a cover, the cover being transparent, such that a user can show an identification card without having to remove it from the pocket. At least one ring can be provided in the pocket, such that a user can clip items to the ring, such as keys. Finally, at least one currency pocket can be provided in the pocket to store physical currency such as bills, and/or coins. A band can be affixed to at least one of the first cover or the second cover and can be utilized to secure the first cover and second cover in a closed configuration. A strap having at least one second fastener disposed at each end can be provided and can be attached to the spine via at least two attachment points disposed thereon.

### BRIEF DESCRIPTION OF THE DRAWINGS

FIG. 1 is a schematic view of an embodiment of a multipurpose journal shown open, according to aspects of the present invention;

FIG. 2 is a front elevation view an embodiment of a multipurpose journal, according to aspects of the present invention;

FIG. 3 is another schematic view of an embodiment of a multipurpose journal shown open, according to aspects of the present invention;

FIG. 4 is a rear elevation view of an embodiment of a multipurpose journal, according to aspects of the present invention;

FIG. 5 is an interior view of a pocket 20 of a multipurpose journal, according to aspects of the present invention; and

FIG. 6 is an another schematic view of an embodiment of a multipurpose journal showing attachment points, according to aspects of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a multipurpose journal. The multipurpose journal of the present invention can include a book portion including a plurality of pages, a strap attached to the book portion by a plurality of attachments disposed on a binding of the book portion, cover portion of the book portion including at least one securable pocket, and a plurality of components disposed within the securable pocket configured to store, or house, items.

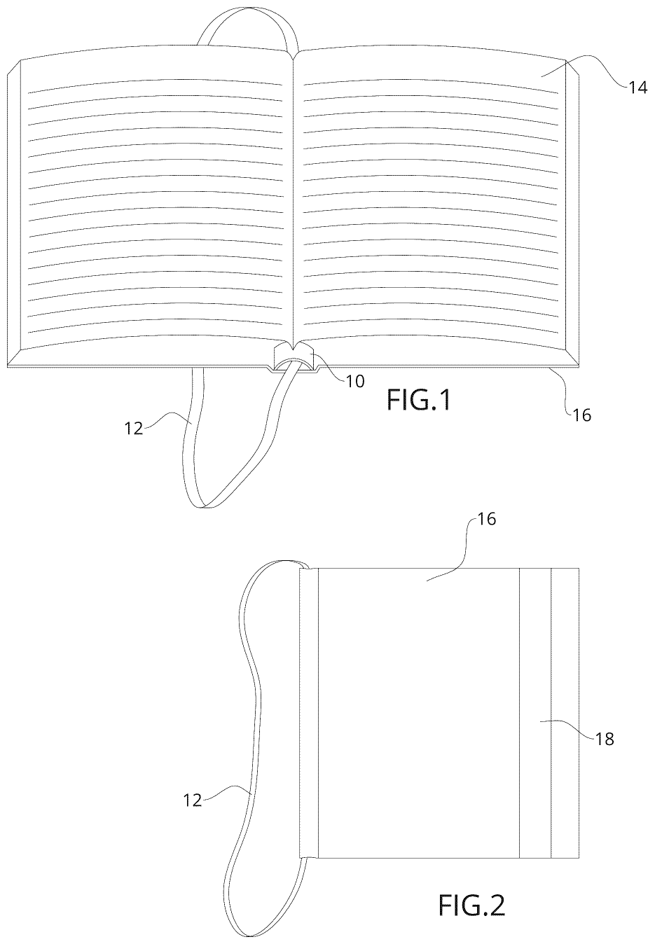

Referring now to FIGS. 1-5, aspects of a multipurpose journal are illustrated. FIG. 1 illustrates a schematic view of the multipurpose journal in an open configuration. In embodiments, the multipurpose journal, in the open configuration can expose a number of pages 14, bound to a soft cover binding 16, which allow a user to write information within the journal. A plurality of straps 10 can be disposed along the binding and can be configured to secure items for journaling, such as a writing instrument. In embodiments, plurality of straps 10 can include at least two straps, each disposed at a differing end of the spine 11 of soft cover binding 16, preferably an interior portion of spine 11. Additionally, a strap 12 can be secured to the spine 11 of soft cover binding 16, by a plurality of attachments 34, described hereinafter, and are configured to allow a user to transport the multipurpose journal by draping strap 12 over at least one shoulder of a user.

FIG. 2 illustrates a front view of a multipurpose journal, shown in storage or transportation configuration. While stored, or transported, soft cover binding 16 can be secured by a band 18 configured to prevent opening of soft cover binding 16. In embodiments band 18 can include a flexible, or stretchable material, such as elastic, or other flexible materials known in the art. In embodiments, band 18 can be affixed to a portion of soft cover binding 16, such as a back portion, or front portion, and can be stretched around soft cover binding 16 by a user to secure the multipurpose journal. Alternatively, band 18 can be separate from the multipurpose journal and can be stored in a pocket 20, described hereinafter, of the multipurpose journal when not in use.

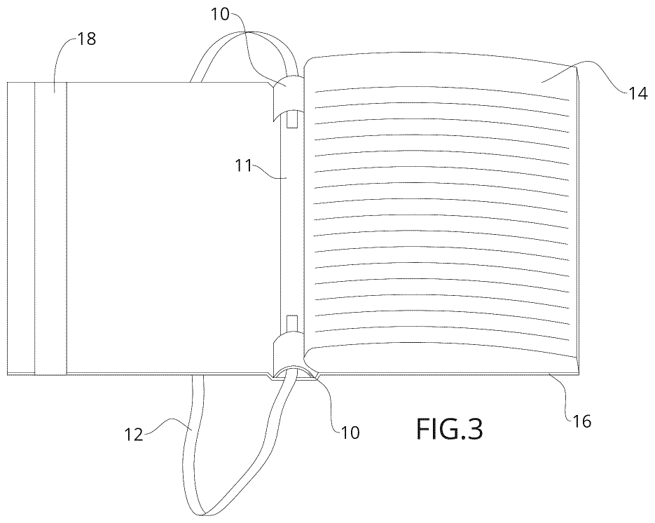

FIG. 3 illustrates an open view, similar to FIG. 1, of a multipurpose journal several components more clearly visualized. Plurality of pages 14 are disposed to a first side of the multipurpose journal, such that a first pages of the plurality of pages is adapted to be written on. An interior aspect of spine 11 is more clearly visualized, as are plurality of straps 10. As illustrated, each of plurality of straps 10 are affixed to a differing end of spine 11 and are configured to accept one or more items for storage, such as a pen. Additionally, plurality of straps 10 are configured to cover fastening mechanism for strap 12, such as sewing, stapling, or other known fasteners in the art. As illustrated, band 18 can be affixed to a surface of soft cover binding 16, in this view an interior of a front cover of soft cover binding 16. Band 18 can be stretched, pulled, or otherwise actuated to extend over a rear cover of soft cover binding 16, thereby securing soft cover binding 16 in a closed configuration.

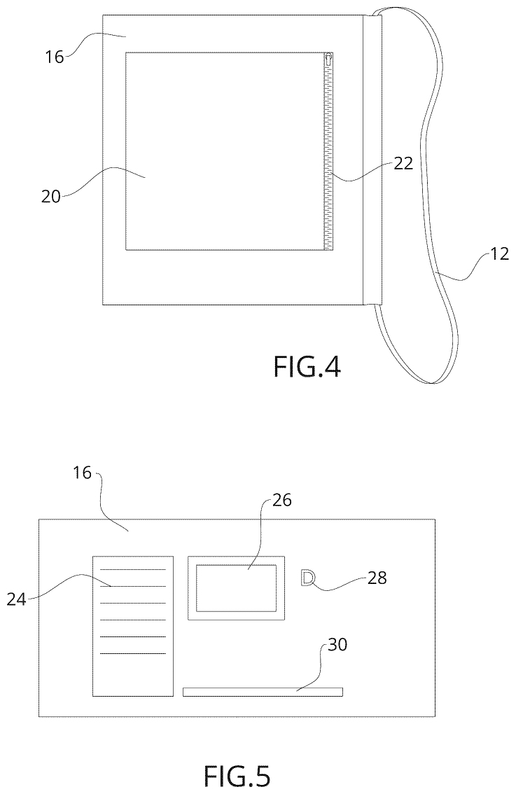

FIG. 4 illustrates a back view of a multipurpose journal, shown in storage or transportation configuration. A back portion of soft cover binding 16 can include a securable pocket 20. In embodiments, securable pocket 20 can be secured by a fastener 22 to prevent loss of items and valuables. In embodiments, fastener 22 can be a zipper, but is not so limited, as any fastening mechanism known in the art, such as buttons, hook and loop fasteners, clips, magnets, etc., are envisioned. In embodiments, a user can store items in securable pocket 20, while not in use, and can retrieve items, as needed for usage. In embodiments, securable pocket 20 can be movable, such as an accordion pocket, to expose a plurality of internal components. Advantageously, securable pocket 20 provides a user the ability to store items, or valuables, directly within soft cover binding 16 of the multipurpose journal thereby eliminating the need for additional storage items, such as a purse, wallet, etc.

FIG. 5 illustrates an interior view of securable pocket 20. Securable pocket 20 can include a plurality of components configured to secure, or store, items therein. In embodiments, the plurality of components can include, but are not limited to, a plurality of card slots 24, an identification card slot 26, at least one ring 28 and at least one currency slot 30. In embodiments, plurality of card slots 24 can include internal recessed portions sized, or dimensioned, to fit standard card sizes, such as credit cards, debit cards, insurance cards, etc., and are configured to provide friction fitting between a card and one of the plurality of slots 24 such that a card can be secured. In embodiments, the plurality of slots 24 are oriented vertically such that each card overlaps latitudinally at least one other card when stored in one of the plurality of slots 24. Alternatively, plurality of slots 24 can be oriented horizontally such that each card overlaps longitudinally at least one other card when stored in one of the plurality of slots 24. Advantageously, plurality of slots 24 can minimize the amount of space for securely storing cards utilizing and overlapping configuration.

An identification card slot 26 can be provided in pocket 20 and can be configured to store an identification card. In embodiments, identification card slot 206 can include internal recessed portions sized, or dimensions, to fit standard government issued identifications, such as state identifications, driver's license, etc. In embodiments, identification card slot 26 can be affixed to back of pocket 20 along three sides of identification card slot 26, leaving a single opening along one side, thereby allowing a user to insert and remove a card from one side only. Alternatively, identification card slot 26 can be affixed to pocket 20 along two parallel sides, such as the two vertical sides, or the two horizontal sides, thereby allowing a user to insert and remove a card from either of two sides. In embodiments, identification card slot 26 can include transparent front portion, such that when a card is disposed within slot 26 a user can provide visual access to the card disposed therein without having to remove the card from slot 26.

At least one ring 28 can be provided in pocket 20 and can be configured to secure items, such as keys. In embodiments, at least one ring 28 can be a key ring, such that a user can install one or more keys securely thereon. Alternatively, at least one ring 28 can be a ring configured to accept clips, claps, or other attachment mechanisms known in the art, such that valuable items can be securely affixed to at least one ring 28.

At least one currency slot 30 can be provided in pocket 20 and can be configured to secure currency, such a monetary notes, or coins, therein. In embodiments, at least one currency slot 30 can be a money clip configured to securely hold monetary notes. Alternatively, at least one currency slot 30 can include internal recessed portions configured to store monetary notes. Advantageously, at least one currency slot 30 allows a user to carry monetary notes without the need for a separate purse, billfold, wallet, etc.

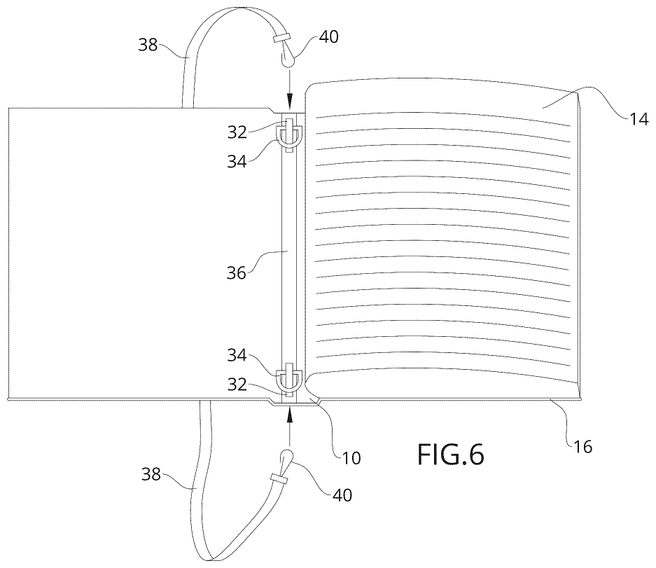

FIG. 6 illustrates a top view of the multipurpose journal including an alternate strap 38 and fasteners 34. A spine of the multipurpose journal can include a plurality of anchors 34 for strap 38. In embodiments, plurality of anchors 34 can be D-rings, but are not so limited. Plurality of anchors 34 can be affixed to the spine of the multipurpose journal utilizing one or more attachments 32. In embodiments, a spine protector 36 can be disposed along the spine of the multipurpose journal and can be configured to provide anchor points for one or more attachments 32. In embodiments, each of the plurality of anchors 34 is affixed to the spine of the multipurpose journal by enclosing a portion of the anchor 34 between at least one attachment 32 and spine protector 36. For example, each anchor 34 can be affixed to spine protector 36 by placing at least one attachment 32 over a portion of the anchor 34 and sewing, or otherwise affixing the at least one attachment 32 to spine protector 36. Advantageously, spine protector 36 can serve as an attachment point for plurality of anchors 34 without damaging soft cover binding 16.

A user can utilize the multipurpose journal as both a journal and a storage device by opening fastener 22 of pocket 20, and placing one or more items in one or more of plurality of card slots 24, identification card slot 26, at least one ring 28 and at least one currency slot 30. User can them secure the items by closing fastener 22, and placing strap 12 around a portion of their body for transportation. User can access any of the one or more items at any time by opening fastener 22 and removing one or more of the items from pocket 20. Additionally, user can journal by removing band 18 and opening the multipurpose journal exposing plurality of pages 14. User can remove a writing implement, such as a pen, if stored on one of the plurality of straps 10 and can then write on the plurality of pages 14. Once finished, user can store the writing implement on one or the plurality of straps 10, and can secure the journal closed utilizing band 18.

It should be understood, of course, that the foregoing relates to exemplary embodiments of the invention and that modifications may be made without departing from the spirit and scope of the invention as set forth in the following claims.

1. A multipurpose journal, comprising:
a first cover continuously attached to a second cover having a spine disposed between the first cover and the second cover;
a plurality of pages operatively connected to an internal surface of the spine and disposed between the first cover and the second cover;
at least one pocket disposed within at least one of the first cover or the second cover, the at least one pocket being closeable by at least one first fastener, wherein the at least one pocket includes:
a first plurality of card pockets that at least partially overlap and are in alignment;
at least one identification card pocket having at least one opening and a cover, the cover being transparent;
at least one ring; and
at least one currency pocket;
a band affixed to at least one of the first cover or the second cover, the band configured to secure the first cover to the second cover;
a strap having at least one second fastener disposed at each end;
at least two attachments disposed on an interior surface of the spine, the at least two attachments configured to engage with the at least one second fastener.

2. The multipurpose journal of claim 1, wherein the at least one first fastener is a zipper, at least one button, or a magnet.

3. The multipurpose journal of claim 1, wherein the first plurality of card pockets are in vertical alignment.

4. The multipurpose journal of claim 1, wherein the first plurality of card pockets are in horizontal alignment.

5. The multipurpose journal of claim 1, wherein the band is made from elastic.

6. The multipurpose journal of claim 1, further comprising:
a spine protector disposed on the spine.

7. The multipurpose journal of claim 1, further comprising:
a plurality of straps disposed on an inner surface of the spine, the plurality of straps configured to secure a writing implement.
